(19) United States
(12) Patent Application Publication
(10) Pub. No.: US 2005/0132082 A1
(43) Pub. Date: Jun. 16, 2005

(54) System and method for resuming downloading from interruption points

(75) Inventors: Chung-I Lee, Tu-Cheng (TW); Chien-Fa Yeh, Tu-Cheng (TW); Yue-Shu Xie, Shenzhen (CN); Qing-Ming Wu, Shenzhen (CN); Xin Cao, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry Co., LTD., Tu-Cheng City (TW)

(21) Appl. No.: 10/929,008

(22) Filed: Aug. 27, 2004

(30) Foreign Application Priority Data
Dec. 12, 2003 (TW) 092135161

(51) Int. Cl. G06F 15/16

(52) U.S. Cl. 709/231; 709/232

(57) ABSTRACT

A system for resuming downloading from interruption points includes an application server (1), a local database (5), and client computers (3). The client computers are provided for users to set download conditions which define a scope of a download. The application server includes a data downloading module (11), a download record determining module (12), and an interruption point obtaining module (13). The download record determining module determines whether any download record exists in the local database, in which data were downloaded according to the same download conditions as a current download. If such download record exists in the local database, the interruption point obtaining module obtains a serial number of the last data item registered in the download record, and the data downloading module downloads data from said last data item only. The local database is for storing all the data used and generated by the system.

### BACKGROUND OF THE INVENTION

1. Field of the Invention

The present invention relates to systems and methods for downloading, and particularly to a system and method which can resume downloading from interruption points.

2. Prior Art of the Invention

As web communication technology develops, more and more web information and service suppliers are providing users with data download capability via networks. Users can transmits download conditions to the suppliers via the networks and directly download data from remote servers of the suppliers.

When users search for required data via the network, most web sites provides the users with data search facilities. The users can set and submit the download conditions, and then obtain a display of corresponding downloadable data from a remote database. Generally, an information-providing web site provides a download function which only allows users to download data of one file at a time. If a user wants to download all the data which match with the download conditions, he or she must manually download the data of each file one by one. When the required data includes a large number of files, the user must spend a lot of time to download all the required data. In addition, if the network temporarily breaks down or experiences other difficulties which interrupt the download, the user must repeat the downloading of the required data, including the data which was downloaded before the interruption. All these factors result in the wastage of user time and network resources.

U.S. Pat. No. 6,339,785, entitled “Multi-server file download,” discloses a data download system for downloading a file from a plurality of remote servers. The data download system can download a part of the file from each remote server, and then integrate the parts of the file into the single complete file in a client computer.

However, this data download system cannot prevent downloading of data which is already stored in a local database of the client computer. In addition, the data download system cannot re-download any data that have not successfully downloaded a first time by resuming downloading of the data from the point of interruption. Instead, the data download system re-downloads the entire unit of data from scratch. Both these shortcomings waste time and resources.

### SUMMARY OF THE INVENTION

A main objective of the present invention is to provide a system and method for resuming downloading from interruption points, which can automatically check a local database before a download, and which can re-download data from an interruption point if a first download is incomplete.

To accomplish the above objective, a system for resuming downloading from interruption points (hereinafter “the system”) in accordance with a preferred embodiment of the present invention is provided herein. The system comprises a local database, an application server, and a plurality of client computers. The client computers are used for providing user interfaces and enabling users to set download conditions which define a scope of a download. The local database is used for storing downloaded data, and storing data lists and download records. The application server is used for implementing the resuming downloading function, and comprises: a download condition receiving module for receiving the download conditions from the client computers; a data downloading module for generating a data lists according to the download conditions, and downloading data from a remote database; a download record determining module for determining whether any download record exists in the local database, in which data were downloaded using the same download conditions as a current download; an interruption point obtaining module for obtaining a serial number of the last data item recorded in the download record in which data were downloaded using the same download conditions; and a download completion determining module for determining whether all the data items record in the data lists have been successfully downloaded.

Further, the present invention provides a method for resuming downloading from interruption points. The method comprises the steps of: (a) receiving download conditions of a download from a client computer; (b) generating a data list of the download; (c) determining whether any download record exists in a local database in which data were downloaded according to the same download conditions as the received download conditions; (d) obtaining a serial number of the last data item registered in the download record, if such download record exists in the local database in which data were downloaded according to said same download conditions; (e) downloading data from the last data item registered in the download record, and recording titles and serial numbers of newly downloaded data items in the download record; (f) determining whether all data items recorded in the data list have been successfully downloaded; and (g) continuing to download undownloaded data items according to the data list, if any data items recorded in the data list have not been downloaded.

Other objects, advantages and novel features of the present invention will be drawn from the following detailed description of the preferred embodiment and a preferred method of the present invention, with reference to the attached drawings, in which:

### BRIEF DESCRIPTION OF THE DRAWINGS

FIG. 1 is schematic diagram of hardware infrastructure a system for resuming downloading from interruption points in accordance with the preferred embodiment of the present invention;

FIG. 2 is a schematic diagram of main function modules of an application server of the system of FIG. 1; and

FIG. 3 is a flowchart of the preferred method for implementing the system of FIG. 1.

### DETAILED DESCRIPTION OF THE PREFERRED EMBODIMENT

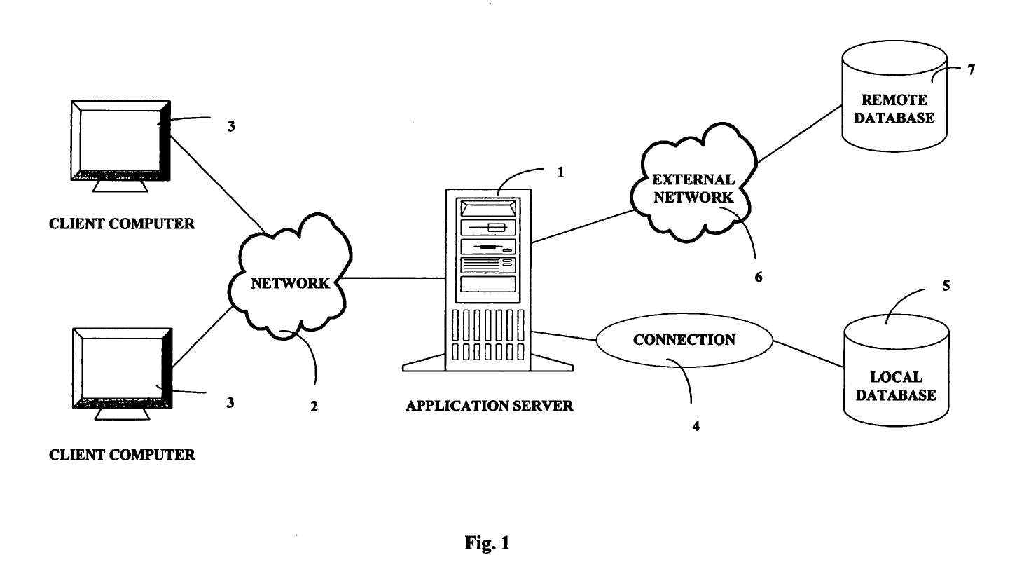

FIG. 1 is a schematic diagram of hardware infrastructure of a system for resuming downloading from interruption points (hereinafter “the system”) according to the preferred embodiment of present invention. The system comprises an application server 1, a local database 5 and a plurality of client computers 3. The client computers 3 are connected to the application server 1 via a network 2. The network 2 may be any suitable communication architecture required by the system, such as an intranet or the Internet. The application server 1 is connected to a remote database 7 via an external network 6, and is connected to the local database 5 via a connection 4. The remote database 7 may be any external network-accessible database which stores downloadable data, such as a patent database managed by a patent office of a country or patent authority. The connection 4 is a database connectivity, such as an Open Database Connectivity (ODBC) or a Java Database Connectivity (JDBC).

The client computers 3 are used for providing user interfaces that enable users to set download conditions for a download, and for displaying relevant information on the download. The download conditions define a scope of the download, and may include an IP (Internet Protocol) address of the remote database 7, and key words of the download. The application server 1 is used for downloading data from the remote database 7 according to the download conditions set by the users, and for generating data lists and download records when downloading the data. Each data list includes a title list and a number list. The title list records titles of the data items which match with the download conditions. The number list records serial numbers of the data items. According to the preferred embodiment, the serial number of a data item indicates a location of the data item in a corresponding data list. For example, a serial number “10” of a data item means that the data item is the tenth data item in the corresponding data list. The download records register a title and serial number of each downloaded data item. The local database 5 is used for storing the downloaded data, the data lists and the download records.

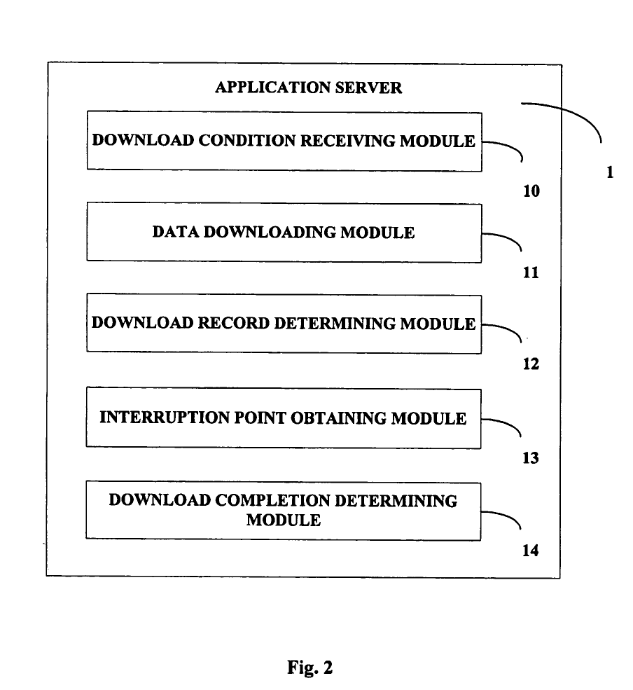

FIG. 2 is a schematic diagram of main function modules of the application server 1. The application server 1 comprises a download condition receiving module 10, a data downloading module 11, a download record determining module 12, an interruption point obtaining module 13, and a download completion determining module 14. The download condition receiving module 10 is used for receiving download conditions, which define a scope of a download from any of the client computers 3. The data downloading module 11 is used for generating a data list according to the download conditions, and downloading data from the remote database 7. The download record determining module 12 is used for checking the local database 5, and determining whether any download record exists in which data were downloaded according to the same download conditions as a current download. If such download record exists, it means that the data required by the current download have been downloaded before. The interruption point obtaining module 13 searches for the last data item registered in the download record, and obtains a serial number of the last data item. Then, the data downloading module 11 downloads data from the last data item. According to the preferred embodiment, when an interruption occurs in the middle of a download, the interruption point at which the download stops is indicated by the serial number of the last data item registered in a corresponding download record. If no such download record exists, the data downloading module 11 downloads data from the first data item recorded in the data list, and generates a corresponding download record to register downloaded data items. The download completion determining module 14 is used for determining whether all data items that match with the download conditions are successfully downloaded according to the data list stored in the local database 5.

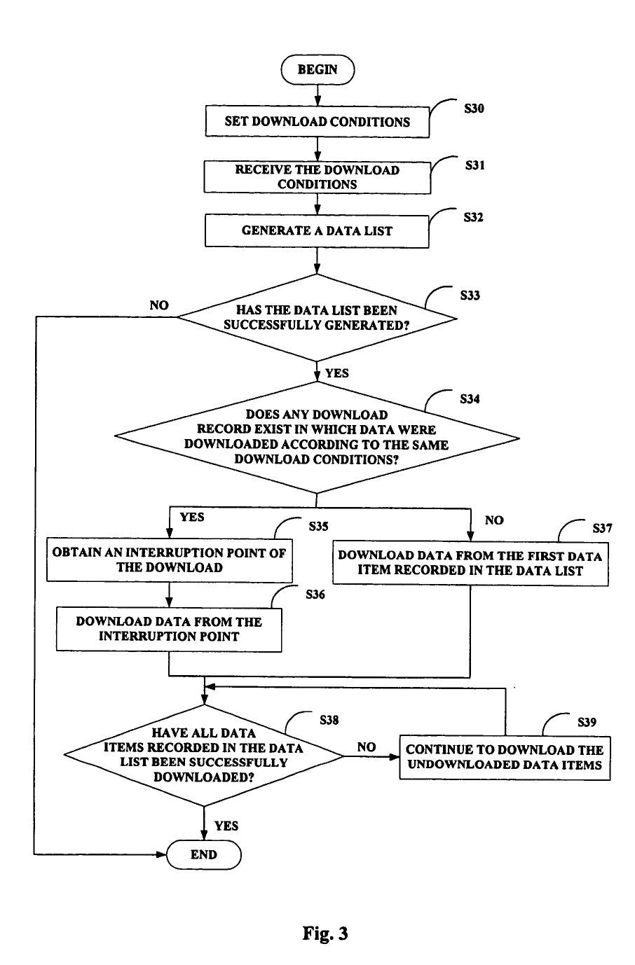

FIG. 3 is a flowchart of the preferred method for implementing the system. In step S30, a user sets download conditions, including an IP address of the remote database 7 and key words of a download, via the user interface of a client computer 3 in order to define the scope of the download. In step S31, the download condition receiving module 10 receives the download conditions from the client computer 3. In step S32, the data downloading module 11 searches in the remote database 7 for required data according to the download conditions, and generates a data list accordingly. In step S33, the data downloading module 11 determines whether the data list has been successfully generated. If the link between the application server 1 and the remote database 7 breaks down, or there is no data in the remote database 7 which match with the download conditions, or any other event occurs which leads to a failure to generate the data list, then the procedure is ended. If the data list has been successfully generated, in step S34, the download record determining module 12 determines whether any download record exists in the local database 5 in which data were downloaded according to the same download conditions.

If such download record exists in the local database 5, in step S35, the interruption point obtaining module 13 obtains a serial number of the last data item recorded in the download record. That is, the interruption point obtaining module 13 obtains information on an interruption point of the corresponding download. Then in step S36, the data downloading module 11 downloads data from the interruption point of the download according to the data list, and registers titles and serial numbers of newly downloaded data items in the download record, whereupon the procedure goes to step S38 described below. If no such download record exists in the local database 5, in step S37, the data downloading module 11 downloads data from the start of the data list. That is, the data downloading module 11 downloads data from the first data item recorded in the data list, and generates a corresponding download record to register titles and serial numbers of downloaded data items, whereupon the procedure goes to step S38 described below.

In step S38, the download completion determining module 14 determines whether all the data items recorded in the data list have been successfully downloaded. If any data items recorded in the data list have not been successfully downloaded, in step S39, the data downloading module 11 continues to download the data items according to the data list, and registers the titles and serial numbers of the downloaded data items in the download record, whereupon the procedure returns to step S38 described above. If and when all the data items have been successfully downloaded, the procedure is ended.

Although the present invention has been specifically described on the basis of a preferred embodiment and a preferred method, the invention is not to be construed as being limited thereto. Various changes and modifications may be made to the embodiment and method without departing from the scope and spirit of the invention.

1. A system for resuming downloading from interruption points, comprising:
a plurality of client computers, each of the client computers providing a user interface enabling one or more users to set download conditions which define a scope of a download;
a local database for storing downloaded data, data lists and download records; and
an application server for downloading data from a remote database, comprising:
a download condition receiving module for receiving download conditions from any of the client computers;
a data downloading module for generating a data list according to received download conditions, and for downloading data from the remote database;
a download record determining module for determining whether any download record exists in the local database in which data were downloaded according to the same download conditions as a current download;
an interruption point obtaining module for obtaining a serial number of a last data item registered in a download record in which data were downloaded according to the same download conditions as a current download; and
a download completion determining module for determining whether all data items recorded in a data list have been downloaded.

2. The system according to claim 1, wherein the download conditions set by said users comprise an IP (Internet Protocol) address of a remote database and keywords which define the scope of the download.

3. The system according to claim 1, wherein the data downloading module is further used for generating a download record if no download record exists in the local database in which data were downloaded according to the same download conditions as a current download.

4. The system according to claim 1, wherein the data lists are used for recording titles and serial numbers of data items which match the download conditions.

5. The system according to claim 1, wherein the download records are used for registering titles and serial numbers of downloaded data items which match the download conditions.

6. The system according to claim 4, wherein the serial number of each data item indicates a location of the data item in a corresponding data list.

7. The system according to claim 1, wherein the data downloading module is further used for downloading data from the last data item registered in the download record in which data were downloaded according to the same download conditions as a current download.

8. The system according to claim 1, wherein the data downloading module is further used for downloading data from the first data item recorded in the data list if no download record exists in the local database in which data were downloaded according to the same download conditions as a current download.

9. A method for resuming downloading from an interruption point, comprising the steps of:
receiving download conditions, which define a scope of a download, from a client computer;
generating a data list of the download;
determining whether any download record exists in a local database in which data were downloaded according to the same download conditions as the received download conditions;
obtaining a serial number of the last data item recorded in the download record, if a download record exists in the local database in which data were downloaded according to said same download conditions;
downloading data from the last data item reregistered in the download record, and registering titles and serial numbers of newly downloaded data items in the download record; and
determining whether all data items recorded in the data list have been downloaded.

10. The method according to claim 9, further comprising the step of downloading data from the first data item recorded in the data list and generating a corresponding download record for registering titles and serial numbers of downloaded data items, if no download record exists in the local database in which data were downloaded according to said same download conditions.

11. The method according to claim 9, further comprising the step of continuing to download data items according to the data list if any data items recorded in the data list have not been downloaded.

12. A method for resuming data downloading after an interruption of data transmission, comprising the steps of:
detecting and acquiring a data download request and related download conditions thereof;
generating a data list having at least one distinguishable serial number thereon for said data download request corresponding to said related download conditions;
executing data-download based on a result of comparing said data list and said at least one serial number thereof with a download record of a local database, said data-download including one step of an group consisting of downloading request data as a whole, downloading parts of said request data according to said comparing result of said data list and said at least one distinguishable serial number with said download record, and acquiring download data of said local database matching with said request data according to said comparing result;
renewing said download record of said local database based on said data-download; and
repeating said executing and renewing steps before said request data being all available in said local database.

13. The method according to claim 12, wherein said data list further comprises a title list to describe a plurality of data items in said requested data in accordance with said download conditions.

14. The method according to claim 12, wherein said data-download is executed as downloading parts of said request data in a condition that said at least one serial number is not available on said download record.
